(19) United States
(12) Patent Application Publication
(10) Pub. No.: US 2014/0047319 A1
(43) Pub. Date: Feb. 13, 2014

(54) CONTEXT INJECTION AND EXTRACTION IN XML DOCUMENTS BASED ON COMMON SPARSE TEMPLATES

(71) Applicant: Peter Eberlein, Malsch (DE)

(72) Inventor: Peter Eberlein, Malsch (DE)

(73) Assignee: SAP AG, Walldorf (DE)

(21) Appl. No.: 13/584,112

(22) Filed: Aug. 13, 2012

(51) Int. Cl. G06F 17/00

(52) U.S. Cl. 715/234

(57) ABSTRACT

A computer-implemented method includes obtaining an XML document template object in which a subset of fields of the XML document is designated by placeholders. The XML document template object is prepared based on a prior instance of the XML document. The method further involves processing the subset of fields in an instance of the XML document that are designated by placeholders in XML document template object.

### BACKGROUND

Information is exchanged on computer networks and the Internet (e.g., between applications, servers or data stores) using documents that are encoded in a format that is both human-readable and machine-readable. A technical standard markup language—Extensible Markup Language (XML) or other XML-based language is used to encode the documents in a flexible text format.

XML is defined, for example, by XML 1.0 Specification set forth by the World Wide Web Consortium (W3C), and by several other related specifications. Although the design of XML focuses on documents, it is also widely used for the representation of arbitrary data structures, for example in web services. Many application programming interfaces (APIs) have been developed to process XML data, and several schema systems and protocols are available to aid in the definition of XML-based languages.

Due to the importance of having documents that can be created, used or accessed by diverse heterogeneous systems, the XML specifications set forth a well-defined, and detailed “standard” structure for XML encoded documents. The structure includes both mandatory and optional fields. An XML-encoded document can be large or voluminous because it must include all of the mandatory fields, and consequently, programs to render or parse an XML document tend to be large or voluminous.

A variety of APIs for accessing XML documents have been developed and used, and some have been standardized. The APIs for processing an XML document include, for example, tree-traversal APIs accessible from a programming language such as Document Object Model (DOM), and stream-oriented APIs accessible from a programming language such as SAX or StAX, APIs based on XML data binding that provides an automated translation between an XML document and programming-language objects, and APIs based on declarative transformation languages such as XSLT and XQuery.

Widely-used DOM is an interface-oriented application programming interface which represents the XML document's contents as a tree of node objects. Data types in DOM nodes are abstract; implementations provide their own programming language-specific bindings. DOM implementations tend to be memory intensive, as they generally require the entire XML document to be loaded into memory and constructed as a tree of objects before access to the document is allowed. Even if a user application needs information from only a few fields contained in the XML document, the entire document has to be to be loaded into memory and processed fully as a tree of node objects. Stream-oriented APIs (e.g., using StAX) require less memory and, for certain tasks which are based on a linear traversal of an XML document, are faster and simpler than other alternatives. However, these stream-oriented API's cannot be used for rendering a new XML document, and in any case require substantial program code development which is both time consuming and error prone.

Consideration is now being given to systems and methods for processing XML documents. In particular, attention is directed to scenarios where a user application needs to extract or modify information in only small portions of an XML document.

### SUMMARY

A solution for rendering or parsing an XML document uses an XML document template to identify a sparse subset of fields in the XML document that are, for example, of interest or relevance to an application. With the solution, the application need not process the entire XML document directly or fully. Processes for rendering or parsing the XML document are limited to processing the identified sparse subset of fields, which can be accessed via a hierarchical context of name/value pairs. The solution, by sharing one XML document template between client and server, enables rapid integration of application systems based on diverse XML technology. The use of the sparse XML document template minimizes development effort required for integration of the application systems because only sub portions of XML documents need to be defined or processed.

In one general aspect, a computer-implemented method for processing XML documents is carried out by causing at least one processor to execute instructions recorded on a computer-readable storage medium. The computer-implemented method includes obtaining an XML document template object in which a subset of fields of an XML document are marked or designated by placeholders. The XML document template object is prepared based on a prior instance of the XML document. The subset of fields of the XML document that are designated by placeholders contain information relevant as input or output of an application function. The method further involves processing the subset of fields in an instance of the XML document that are designated by placeholders in the XML document template object. Only the subset of fields for which placeholders are defined in the XML document template object (and mandatory XML fields) may be processed.

In another aspect, the computer-implemented method involves extracting information from the subset of fields in the XML document using the XML document template object as reference. In yet another aspect, the computer-implemented method involves parsing the XML document which returns a context object having a dictionary of key-value pairs with the placeholders as keys.

In another aspect, the computer-implemented method involves rendering an instance of the XML document by inserting information in the fields associated with the placeholders defined in the XML document template. The inserted information can be generated at runtime and/or derived from a context object having a dictionary of key-value pairs with the placeholders as keys.

In one general aspect, a computer program product, which is embodied in non-transitory computer-readable media carrying executable code, includes code which when executed obtains an XML document template object in which a subset of fields of an XML document are marked or designated by placeholders. The code when executed processes the subset of fields in the XML document that are designated by placeholders in XML document template object. In an aspect, the code when executed extracts information from the subset of fields in the XML document using the XML document template object as reference. In another aspect, the code when executed parses the XML document to return a context object having a dictionary of key-value pairs with the placeholders as keys. In yet another aspect, the code when executed renders an instance of XML document by inserting information in the subset of fields associated with the placeholders defined in the XML document template.

In one general aspect, a computer-based system, which is implemented by instructions recorded on a non-transitory computer readable storage medium and executable by at least one processor, includes a processor and a computer readable storage medium. The computer readable storage medium carries an XML document template object in which a subset of fields of an XML document is marked or designated by placeholders. The processor is configured to process an instance of the XML document with reference to the XML document template object. In one aspect, the processor is configured to extract information from the subset of fields in the instance of the XML document that are designated by placeholders in the XML document template object. In another aspect, the processor is configured to render an instance of the XML document by inserting information in the subset of fields that are designated by placeholders in the XML document template object.

The details of one or more implementations are set forth in the accompanying drawings and the description below. Other features will be apparent from the description and drawings, and from the claims.

### BRIEF DESCRIPTION OF THE DRAWINGS

FIG. 1 is a block diagram illustration of an example system for implementing a solution for processing an XML document with a computing device application, in accordance with the principles of the disclosure herein.

FIG. 2 is a flow diagram illustration of an example method FIG. 2 shows an example computer-implemented method 200 for processing XML documents, in accordance with the principles of the disclosure herein, in accordance with the principles of the disclosure herein.

### DETAILED DESCRIPTION

An XML document may include mandatory fields and optional fields. Elements are the main building block of any XML document. The elements contain data and determine the structure of the document. An element can be defined within an XML Schema.

For convenience in description, the following terminology is adopted herein:

XML Schema—An XML schema formally describes what a given XML document contains as what fields an element can contain and which sub elements it can contain, etc. The schema can also describe the values that can be placed into any element or attribute. An element can be defined within the schema, for example, as follows:
<schema: element name=“x” type=“y”/>
The name property in the foregoing definition is the name that will appear in the XML document, and the type property provides a description of what type of data can be contained within the element when it appears in the XML document.
Attribute—An attribute provides extra information within an element. Attributes have name and type properties that are defined within the schema, for example, as follows:
<xs:attribute name=“x” type=“y”/>.
An attribute can appear within a given element in an XML document.
Cardinality—Cardinality specifies how many times an element can appear in an XML document.
Dictionary—A dictionary is a list of key and value pairs (e.g., Dictionary<key, value>).
Context—A context is a dictionary of key-value pairs in an XML document. A context can be a hierarchical structure, although unless explicitly declared, a deep structure may be flattened into one context as long as the cardinality of parent element to child element in the XML document is one-to-one. For one-to-many parent element to child element relations, a context may include an object (e.g., an array) that supports enumeration. This array object then contains another context for each XML child element. The context may be a key-value dictionary that is returned on parsing any XML document. A new XML document may be rendered by passing or inserting any key-value-compliant object to the document.

A solution for processing an XML document by a computing device application involves comparison or reference to an XML document template, in accordance with the principles of the disclosure herein. The XML document may contain mandatory fields and optional fields, for example, as defined by an XML schema. Some of the fields in the XML document, whether mandatory or optional, may have “fixed” values which the computing device application may have no need to change or process (i.e. their values may be fixed at least from the perspective of the computing device application). The computing device application may have a need to change or process only some of the mandatory and/or optional fields, which may have “variable” values from the perspective of the computing device application. The XML document template may be created from an instance of the XML document by placing “placeholder” elements in one or more mandatory or optional fields in the XML document instance that may have variable values from the perspective of the computing device application. The XML document template may have fields with placeholder elements limited specifically to the few fields that are of interest or relevant, for example, as input or output data of a function of the computing device application. The XML document template may omit all fields in the XML document that are not of interest or relevant to the computing device application, and thus may be substantially sparse in comparison, for example, with a DOM tree of the XML document.

The computing device application may render, create or modify an XML document by inserting information, which may be generated at runtime, in the few fields associated with the placeholder elements defined in the XML document template. Similarly, the same or other computing device application may extract context information from an existing XML document by processing only the few fields in the existing XML document that correspond to fields with placeholder elements in the XML document template.

The foregoing solution for processing an XML document by a computing device application may be implemented on any computing platform or in configuration of one or more computing devices. The one or more computing devices may, for example, be stand-alone computing devices, or one or more physical or virtual machines on a computer network (e.g., in a cloud computing network). The one or more computing devices may include personal computing devices (e.g., mobile phones, desktops, tablets, notebooks, etc.) and/or business or industrial computing systems (e.g., mainframes, servers, etc.).

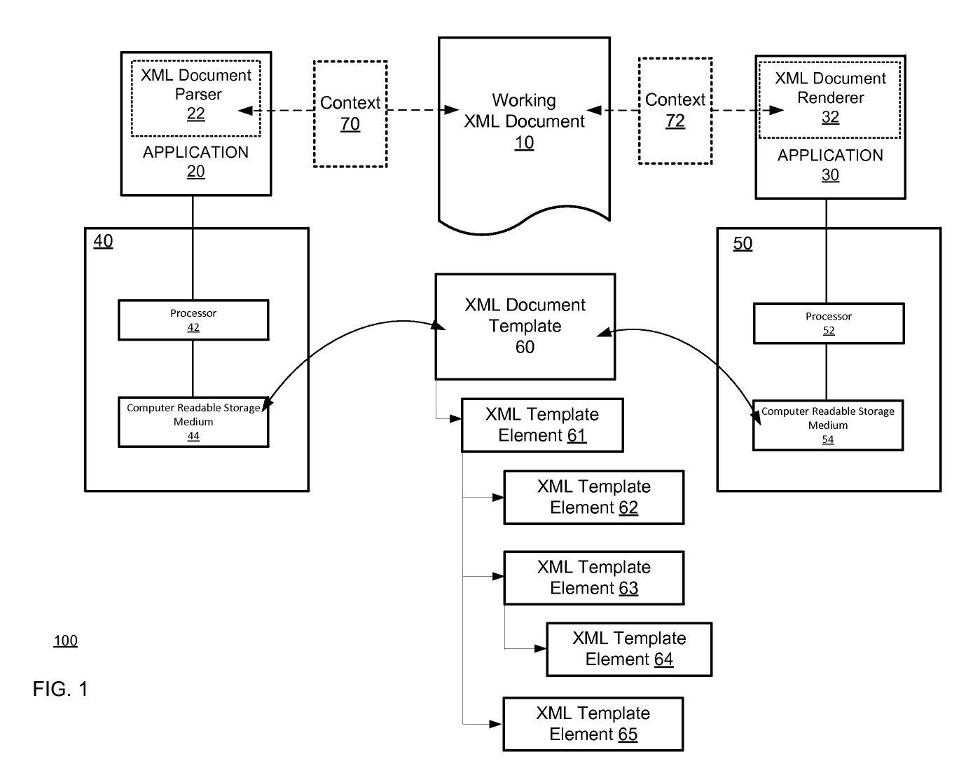

FIG. 1 shows an example system 100 for implementing the foregoing solution for processing an XML document with a computing device application, in accordance with the principles of the disclosure herein. In particular, system 100 shows an example scenario in which an XML document (e.g., instance “working XML document 10”) is processed, for example, by computing device applications 20 and 30 with reference to XML document template 60.

In the example scenario, computing device applications 20 and 30 may be hosted on computing devices 40 and 50 that include processors 42 and 52 coupled to computer readable storage mediums 44 and 54, respectively.

Computing device applications 20 and 30, which are shown for example as being hosted on computing devices 40 and 50, respectively, may be the same or different applications. The computing device applications may have been coded (e.g., by application developers) to have functions which require information from or modify information in select fields of an XML document (e.g., working XML document 10). For this purpose, the computing device applications may include suitable routines (e.g., XML document parser 22, XML document renderer 32) to extract information from XML documents, modify XML documents, or both. For visual clarity and simplicity in the following description, computing device applications 20 and 30 are shown in FIG. 1, for example, as having a XML document parser 22 and a XML document renderer 32, respectively, even though either application 20 or 30 may have both a parser and a renderer. XML document parser 22 and XML document renderer 32 may be configured to use XML document template 60 as reference while processing working XML document 10.

Working XML document 10 may have been prepared by any one of a number of heterogeneous XML implementations or protocols (e.g., ABAP, Java etc.). Further, XML document template 60 may be prepared, for example, based on a previous instance of XML document 10. XML document template 60 may be a sample instance of XML document 10 with particular elements, attributes and content fields replaced with placeholders. XML document template 60 may include objects with placeholder elements placed in the select fields or data that may be interest or relevance to applications 30 and 40. XML document template 60 may have an object structure such that the objects with placeholder elements can be commonly used by both XML document parser 22 and XML document renderer 32 when processing working XML document 10.

FIG. 1 shows an example XML document template 60 as a hierarchy of XML objects (e.g., XML Template Element objects 61-65) that can be commonly used by both XML document parser 22 and XML document renderer 32 for processing working XML document 10. XML Template Element objects 61-65 may mark or identify the select fields or data that may be interest or relevance to applications 30 and 40 with placeholders.

It will be understood that in various XML implementations of system 100, an XML Template class or type may represent instances of template XML documents with embedded placeholders (e.g., instance XML document template 60). The particular placeholders used in an XML document template may be identified in a context object (e.g., context 70 or 72). The context associated with the XML document template may be a key-value dictionary with the placeholders as keys. The context may, for example, be a dictionary that is returned on parsing XML document template 60.

In XML document template 60, the embedded placeholders may, for example, be coded in the format % placeholder %. In contexts 70 and 72, ‘placeholder’ without the % delimiters may be used as keys.

An example snippet of XML document template 60 for an element <Order> in the XML document is as follows:

```
<Order>
  <CustomerID type=‘DUNS’>%customer%</CustomerID>
  <Items xml:contextlist=‘%items%’>
    <ProductID>%product%</ProductID>
    <Quantity uom=‘%uom%’>%quantity%</Quantity>
  </Item>
</Order>.
```

XML elements (e.g., Items) that are repeated or occur more than one time in the XML document may be placed in a context list by declaring a namespace using a reserved namespace prefix (e.g., ‘contextlist’) for the context list, for example, as shown in the third line of the foregoing snippet:
. . . <Items xml:contextlist=‘%items%’>.

This namespace declaration for ‘contextlist’ may anticipate an enumerable object in the XML document template as value of the key ‘item’ specified as placeholder for the contextlist. The enumerable array object may contain key-value-compliant objects, which further may possibly contain other placeholders (e.g., %product%, %quantity%, %uom%,) for sub-elements and attributes (e.g., <Product ID> and <Quantity>, and Quantity uom) in repeated elements.

The namespace declarations for ‘contextlist’ may anticipate key-value-coding compliant objects as value for the keys (e.g., % item %) used as placeholder when rendering an XML document. Similarly, the namespace declarations for ‘contextlist’ may on parsing the XML document, anticipate return a dictionary for the keys (e.g., % item %) used as placeholders.

Other object trees or sub-trees may be created by an XML document template 60. For example, a key-value-coding compliant object in a context may itself be a context (i.e. a sub context). For example, an element <birthday> in a parent context may be a group of sub-elements: <date> and <reminder>. Such a group of sub-elements may be placed in a sub context in the parent context by declaring a namespace using a reserved namespace prefix (e.g., ‘subcontext’). The subcontext may be a dictionary of key-value pairs for the sub-elements grouped together under a key defined by the namespace declaration. An example snippet of XML document template 60 for an element <birthday> in a context may be as follows:

```
<birthday xmlns: subcontext= “%birthday%”>
  <date>%date%</date>
  <reminder>TRUE</reminder>
</birthday>
```

When rendering an XML document, the subcontext namespace declaration for element <birthday> in its parent context may allow values for sub-elements (e.g., <date> and <reminder>) to be entered or omitted as a group according to whether there is value for the key placeholder “%birthday%” in the parent context.

On parsing an XML document, the subcontext declaration may anticipate return of a subcontext dictionary as a value in the parent context key-value pairs. In other words, a context may contain sub contexts, so the value for the key defined by the subcontext namespace declaration may return a dictionary defined by the subcontext declaration.

It will be understood that the foregoing contextlist and subcontext declarations define two different structures that may be individually used exclusively or together in suitable combinations in a context definition. A context may, for example, include only a contextlist, or only a subcontext or array of subcontexts, or a contextlist whose elements include one or more subcontexts.

With renewed reference to FIG. 1, in operation of system 100, instance XML document template 60 may be loaded into memory from a template file that conforms to a format which identifies placeholders and their cardinality. XML document template 60 may also include code to define import of other templates as sub templates, for example, using the XML processing instruction ‘import’ as in <?import subtemplate.xml?>. Alternatively, XML document template 60 may include code either naming a resource that contains the import or naming a placeholder that can be mapped to the actual resource (e.g., <?import %subtemplate%?>) when loading the template into memory.

Once an XML Template (e.g., XML document template 60) is prepared and loaded into memory in system 100 it may be maintained as an un-modifiable data container. Maintaining XML document template 60 as an un-modifiable data container may advantageously allow one instance of XML document template 60 to be shared across multiple threads for multi-threaded rendering and parsing of XML documents. For example, a same instance of XML document template 60 may be used by applications 20 and 30 for parsing and rendering XML documents as shown in FIG. 1.

In system 100, XML document renderer 32 may be used to render an instance of an XML document (e.g., working XML document 10) by substituting placeholders in an XML template object (e.g., XML document template 60) with values provided by a context tree (e.g., context 72).

In operation, XML document renderer 32 may be initialized with a read-only instance of XML document template 60. The initialization may prepare XML document renderer 32 to render any number of documents with different contexts, for example, by invoking a renderContext method to pass a context for substituting placeholders identified in the XML document template. The context (e.g., context 72) may be a hierarchy of dictionary objects that may contain array objects for repeating XML elements, but can be any key-value-coding compliant object. XML document renderer 32 may return a data object that encapsulates the XML document content.

Further, in system 100, XML document parser 22 may be used to parse an instance of an XML document (e.g., working XML document 10) with reference to an XML template object (e.g., XML document template 60). Element content and attributes for which placeholders are defined in the XML template object may be extracted from the XML document and returned by XML document renderer 32 as a tree of dictionary objects with array objects for repeating elements.

In operation, XML document parser 22 may be initialized with a read-only instance of XML document template 60. The initialization may prepare XML document parser 22 to parse any number of contexts from different documents, for example, by invoking a parseData method to pass a data object encapsulating the XML document content. XML document parser 22 may return a dictionary with context information extracted from the XML document elements identified with placeholders in XML document template 60.

In operation of application 20, which may require information only from select fields in working XML document 10, XML document parser 22 may use XML document template 60 to identify and process only the select fields in working XML document 10. XML document parser 22 may extract element content and attributes for which placeholders are defined in XML document template 60, and return the extracted information in context 70. XML document parser 22 may return the extracted information to application 20 in context 70 as a tree of dictionary objects with array objects for repeating elements.

Particular arrangements of applications and computing devices have been described above with reference to FIG. 1. It will be understood that principles of the disclosure herein are not limited to the particular arrangements of applications and computing devices shown in FIG. 1.

In an example use of the foregoing solution for processing an XML document by a computing device application, a client computer may share the following XML document template with an ABAP-based XML server:

```
<?xml version=“1.0” encoding=“utf-8” ?>
<group>
  <name>%name%</name>
  <description>%description%</description>
  <is-private>true</is-private>
</group>.
```

The client computer may send a context/dictionary to the server with a request for information. An example context/dictionary with placeholders as keys for rendering a document instance at the server with the foregoing shared XML document template may be:
name=Financial Closing
description=Collaboration group to prepare the financial closing

The resulting XML document instance with the foregoing context values inserted for placeholders at the server may be:

```
<?xml version=“1.0” encoding=“utf-8”?>
<group>
  <name>Financial Closing</name>
  <description>Collaboration group to prepare the financial
closing</description>
  <is-private>true</is-private>
</group>
```

In another example, a client computer may parse a Java-based XML document received from a server to extract information from selected fields using the following XML Document template:

```
<?xml version=“1.0” ?>
− <ACCOUNT_ACCESS_CONTEXT xmlns=“http://nnn.com/byd/
oberon”>
  − <EXPORTING>
    <EV_CONTEXT>%oauth_token%</EV_CONTEXT>
    <EV_RESPONSE_CODE>%response_code%
    </EV_RESPONSE_CODE>
    <EV_SERVICE_URL>%jam_host%</EV_SERVICE_URL>
    <EV_USER_ACCOUNT>%jam_user%
    </EV_USER_ACCOUNT>
  </EXPORTING>
</ACCOUNT_ACCESS_CONTEXT>.
```

The client computer parser may, using the foregoing template as reference for parsing the Java-based XML document received from a server, return the following context/dictionary:

oauth_token = pOfqCJEPsUwW4uSZgQF6MCBBsz928
GwRODAXNCqa
response_code = 200
jam_host = http://stage.cubetree.com
jam_user = user1@nnn-mcc.com

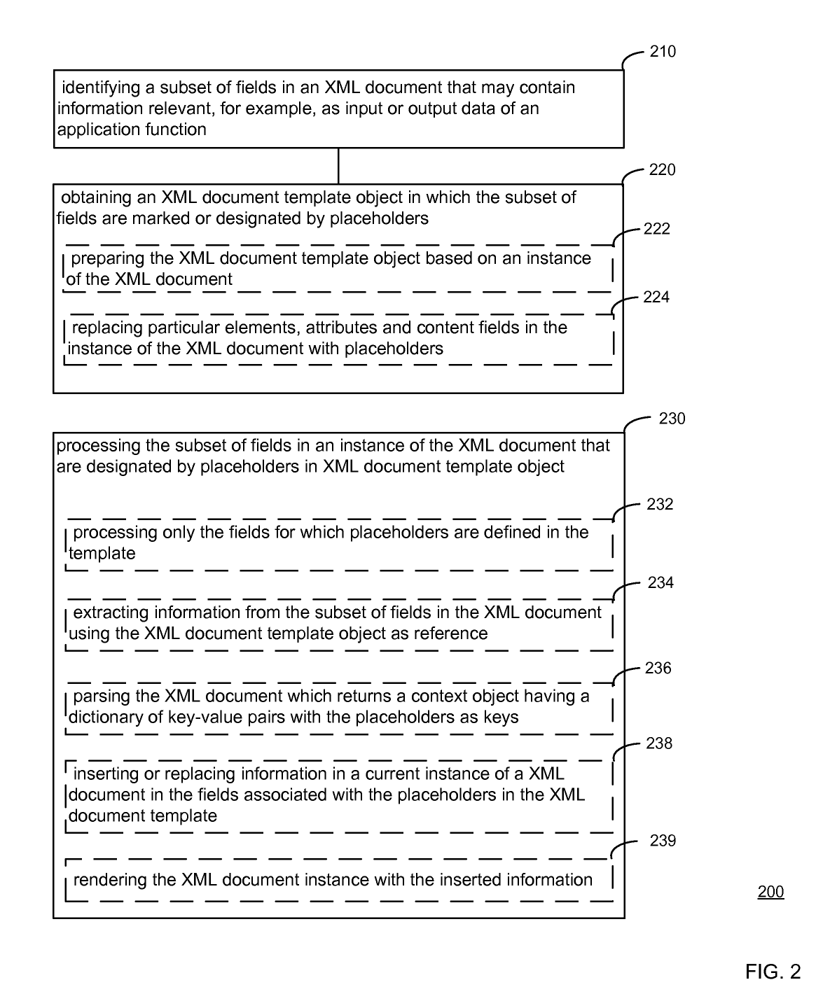

FIG. 2 shows an example computer-implemented method 200 for processing XML documents, in accordance with the principles of the disclosure herein. Method 200 may be used to generically process XML documents in computing environments that may use diverse XML technologies and protocols.

Method 200 includes identifying a subset of fields of interest in an XML document (210), obtaining an XML document template in which the subset of fields are marked or designated by placeholders (220), and processing the subset of fields in a current instance of the XML document that are designated by placeholders in XML document template (230).

In method 200, identifying a subset of fields in an XML document 210 may involve identifying the subset of fields in the XML document that may contain information relevant, for example, as input or output data of an application function. Further, obtaining an XML document template in which the subset of fields are designated by placeholders 220 may involve preparing the XML document template based on a previous instance of the XML document (222) and may involve replacing particular elements, attributes and content fields in the previous instance of the XML document with placeholders (224).

Further in method 200, processing the subset of fields in a current instance of the XML document that are designated by placeholders in XML document template 230 may involve processing only the subset of fields for which placeholders are defined in the template (232). The processing of the subset of fields in a current instance of the XML document that are designated by placeholders in XML document template may include parsing, extracting information, inserting information and rendering the XML document. Processing the subset of fields of in the current instance of the XML document that are designated by placeholders in XML document template 230 may involve parsing the XML document using the XML document template as reference, which returns a context object having a dictionary of key-value pairs with the placeholders as keys (234) and extracting information i.e. the values for the subset of fields (236).

Additionally or alternatively in method 200, processing the subset of fields of the XML document that are designated by placeholders in XML document template object 230 may involve inserting or replacing information in a current instance of a XML document in the fields associated with the placeholders in the XML document template (238), and rendering the XML document instance with the inserted information (239). The inserted information may be generated at runtime and/or may be derived from a context object having a dictionary of key-value pairs with the placeholders as keys.

The various infrastructure, systems, techniques, and methods described herein may be implemented in digital electronic circuitry, or in computer hardware, firmware, software, or in combinations of them. The implementations may be a computer program product, i.e., a computer program tangibly embodied in an information carrier, e.g., in a machine-readable storage device or in a propagated signal, for execution by, or to control the operation of, data processing apparatus, e.g., a programmable processor, a computer, or multiple computers. A computer program, such as the computer program(s) described above, can be written in any form of programming language, including compiled or interpreted languages, and can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

Method steps may be performed by one or more programmable processors executing a computer program to perform functions by operating on input data and generating output. Method steps also may be performed by, and an apparatus may be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. Elements of a computer may include at least one processor for executing instructions and one or more memory devices for storing instructions and data. Generally, a computer also may include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory may be supplemented by, or incorporated in special purpose logic circuitry.

To provide for interaction with a user, implementations may be implemented on a computer having a display device, e.g., a cathode ray tube (CRT) or liquid crystal display (LCD) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Implementations may be implemented in a computing system that includes a back-end component, e.g., as a data server, or that includes a middleware component, e.g., an application server, or that includes a front-end component, e.g., a client computer having a graphical user interface or a Web browser through which a user can interact with an implementation, or any combination of such back-end, middleware, or front-end components. Components may be interconnected by any form or medium of digital data communication, e.g., a communication network. Examples of communication networks include a local area network (LAN) and a wide area network (WAN), e.g., the Internet.

While certain features of the described implementations have been illustrated as described herein, many modifications, substitutions, changes and equivalents will now occur to those skilled in the art. It is, therefore, to be understood that the appended claims are intended to cover all such modifications and changes as fall within the scope of the embodiments.

What is claimed is:

1. A computer-implemented method carried out by causing at least one processor to execute instructions recorded on a computer-readable storage medium, the computer-implemented method comprising:
obtaining an XML document template object in which a subset of fields of an XML document are designated by placeholders; and
processing the subset of fields in an instance of the XML document that are designated by placeholders in XML document template object,
wherein the XML document template object is prepared based on a prior instance of the XML document.

2. The computer-implemented method of claim 1, wherein the subset of fields of the XML document that are designated by placeholders contain information relevant as input or output data of an application function.

3. The computer-implemented method of claim 1, wherein obtaining an XML document template object in which the subset of fields are designated by placeholders includes preparing the XML document template object based on an instance of the XML document.

4. The computer-implemented method of claim 3, wherein preparing the XML document template object based on an instance of the XML document includes replacing particular elements, attributes and content fields in the instance of the XML document with placeholders.

5. The computer-implemented method of claim 1, wherein processing the subset of fields of the XML document that are designated by placeholders involves processing the XML document only for those fields for which placeholders are defined in the XML document template object.

6. The computer-implemented method of claim 1, wherein processing the subset of fields of the XML document that are designated by placeholders involves extracting information from the subset of fields in the XML document using the XML document template object as reference.

7. The computer-implemented method of claim 6, wherein extracting information from the subset of fields in the XML document using the template object as reference involves parsing the XML document which returns a context object having a dictionary of key-value pairs with the placeholders as keys.

8. The computer-implemented method of claim 1, wherein processing the subset of fields of the XML document that are designated by placeholders involves rendering an XML document by inserting information in the fields associated with the placeholders defined in the XML document template.

9. The computer-implemented method of claim 8, wherein the inserted information is generated at runtime.

10. The computer-implemented method of claim 8, wherein the inserted information is derived from a context object having a dictionary of key-value pairs with the placeholders as keys.

11. A computer program product embodied in non-transitory computer-readable media carrying executable code, the computer program product comprising:
code which when executed,
obtains an XML document template object in which a subset of fields of an XML document are designated by placeholders; and
processes the subset of fields in the XML document that are designated by placeholders in XML document template object,
wherein the XML document template object is prepared based on a prior instance of the XML document.

12. The computer program product of claim 11, wherein the code when executed:
prepares the XML document template object based on an instance of the XML document.

13. The computer program product of claim 12, wherein the code when executed:
replaces particular elements, attributes and content fields in the instance of the XML document with placeholders.

14. The computer program product of claim 11, wherein the code when executed:
processes the XML document only for those fields for which placeholders are defined in the XML document template object.

15. The computer program product of claim 11, wherein the code when executed:
extracts information from the subset of fields in the XML document using the XML document template object as reference.

16. The computer program product of claim 11, wherein the code when executed:
parses the XML document to return a context object having a dictionary of key-value pairs with the placeholders as keys.

17. The computer program product of claim 11, wherein the code when executed:
renders an instance of XML document by inserting information in the subset of fields associated with the placeholders defined in the XML document template.

18. A computer-based system implemented by instructions recorded on a non-transitory computer readable storage medium and executable by at least one processor, the computer-based system comprising:
a processor; and
a computer readable storage medium;
wherein the computer readable storage medium carries an XML document template object in which a subset of fields of an XML document are designated by placeholders; and
wherein the processor is configured to process an instance of the XML document with reference to the XML document template object.

19. The computer-based system of claim 18, wherein the processor is configured to extract information from the subset of fields in the instance of the XML document that are designated by placeholders in the XML document template object.

20. The computer-based system of claim 18, wherein the processor is configured to render an instance of the XML document by inserting information in the subset of fields that are designated by placeholders in the XML document template object.
